(19) United States
(12) Patent Application Publication
(10) Pub. No.: US 2010/0049609 A1
(43) Pub. Date: Feb. 25, 2010

(54) GEOGRAPHICALLY TARGETED ADVERTISING

(75) Inventors: WEIHUA (WAYNE) ZHAO, SAMMAMISH, WA (US); OMPRAKASH R. MANIYAR, REDMOND, WA (US); XIANZU SONG, BEIJING (CN); TRAVIS J. MUHLESTEIN, REDMOND, WA (US); HONGHUA (KATHY) DAI, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/197,743

(22) Filed: Aug. 25, 2008

(51) Int. Cl. G06Q 30/00; G06F 7/20; G06F 17/30

(52) U.S. Cl. 705/14.58; 707/4; 707/E17.018; 707/E17.014

(57) ABSTRACT

Methods and computer storage media for geographically targeting online advertisements. A search query is received from a searcher. A geographic location that is associated with the search query is identified and converted to a geographic identifier. A geographic tolerance associated with the search query is determined. An advertisement is matched to the search query based, in part, on the geographic identifier and the geographic tolerance of the search query. The matched advertisement is presented to the searcher. In some embodiments, the advertisement includes an associated geographic tolerance that is utilized for ranking the advertisement. In some embodiments, the direction of travel associated with the searcher is utilized, in part, to rank the advertisement.

### BACKGROUND

Traditionally, online advertisements that are displayed in response to a user-provided search query are contextually relevant to the user-provided search query. Therefore, the user is provided search results and advertisements that are relevant to the context of the user's query. Because the Internet serves a geographically disperse market, local advertisements that are contextually related to a nonlocal search query are displayed to the users without intent to look at local services, or the users that are not in a reasonable geographic proximity. As a result, advertisements that are not geographically relevant to the user are displayed to the user, which generally, does not benefit the user, the advertiser, or the financial benefactor of the Internet page from which the advertisement is displayed.

### SUMMARY

Embodiments of the present invention relate to methods and computer storage media for geographically targeting online advertisements. A search query is received from a searcher. A geographic location that is associated with the search query is identified and converted to a geographic identifier. Additionally, a geographic tolerance associated with the search query is determined. Geographic tolerance is a measurement of acceptable spatial discrepancy between the search query geographic identifier and an advertisement's geographic identifier. One or more advertisements are matched to the search query based, in part, on the geographic identifier and the geographic tolerance. The matched advertisements are presented to the searcher.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram that depicts an environment for geographically targeting online advertisements suitable for use in implementing embodiments of the present invention;

FIG. 3 is a flow diagram of an exemplary method for geographically targeting online advertisements, in accordance with an embodiment of the present invention;

FIG. 4 is a flow diagram of another exemplary method for geographically targeting online advertisements, in accordance with an embodiment of the present invention;

FIG. 5 is a flow diagram of another exemplary method for geographically targeting online advertisements, in accordance with an embodiment of the present invention; and

FIG. 6 is a flow diagram of another exemplary method for geographically targeting online advertisements, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among the various steps herein disclosed unless and except when the order of individual steps is explicitly described.

Embodiments of the present invention relate to methods and computer storage media for geographically targeting online advertisements. A search query is received from a searcher. A geographic location that is associated with the search query is identified and converted to a geographic identifier. Additionally, a geographic tolerance associated with the search query is determined. Geographic tolerance is a measurement of acceptable spatial discrepancy between the search query geographic identifier and an advertisement's geographic identifier. One or more advertisements are matched to the search query based, in part, on the geographic identifier and the geographic tolerance. The matched advertisements are presented to the searcher.

Accordingly, in one aspect, the present invention provides one or more computer-storage media having computer-executable instructions embodied thereon for performing a method of geographically targeting online advertisements. The method includes receiving a search query from a user, identifying a geographic location associated with the search query, and converting the geographic location into a geographic identifier. The method also includes determining a geographic tolerance for the search query. The geographic tolerance is a measurement of acceptable spatial discrepancy between the search query geographic identifier and an advertisement's geographic identifier. The method additionally includes matching the search query to one or more advertisements based on the geographic identifier and the geographic tolerance. The method also includes presenting the one or more advertisements.

In another aspect, the present invention provides a method of geographically targeting online advertisements to a search query. The method includes receiving an advertisement from an advertiser. The advertisement is associated with one or more geographic locations. The method also includes determining a geographic tolerance for the advertisement. The method additionally includes determining one or more geographic identifiers to associate with the advertisement based on the one or more geographic locations and the determined geographic tolerance. The one or more geographic identifiers indicate a geographic area that correlates to the one or more geographic locations including the determined geographic tolerance. The method also includes storing the advertisement in association with the one or more geographic identifiers and communicating the advertisement in response to a search query that is relevant to the advertisement and the advertisement's associated one or more geographic identifiers.

A third aspect of the present invention provides a method of geographically targeting online advertisements to a search query. The method includes receiving a search query from a user. The method also includes identifying a geographic location associated with the search query by detecting the geographic location from the context of the search query or from information received in addition to the search query. The method additionally includes identifying a direction of travel associated with the user. The direction of travel is based on the information received in addition to the search query. The method also includes converting the search query's geographic location into a geographic identifier. The method additionally includes matching the search query to one or more advertisements based on the geographic identifier, the identified direction of travel, and a geographic tolerance associated with each member of the one or more advertisements. The geographic tolerance is determined based on the context of each member of the one or more advertisements or by an advertiser associated with each member of the one or more advertisements. The method also includes presenting the one or more advertisements.

Having briefly described an overview of the embodiments of the present invention, an exemplary operating environment suitable for implementing embodiments hereof is described below.

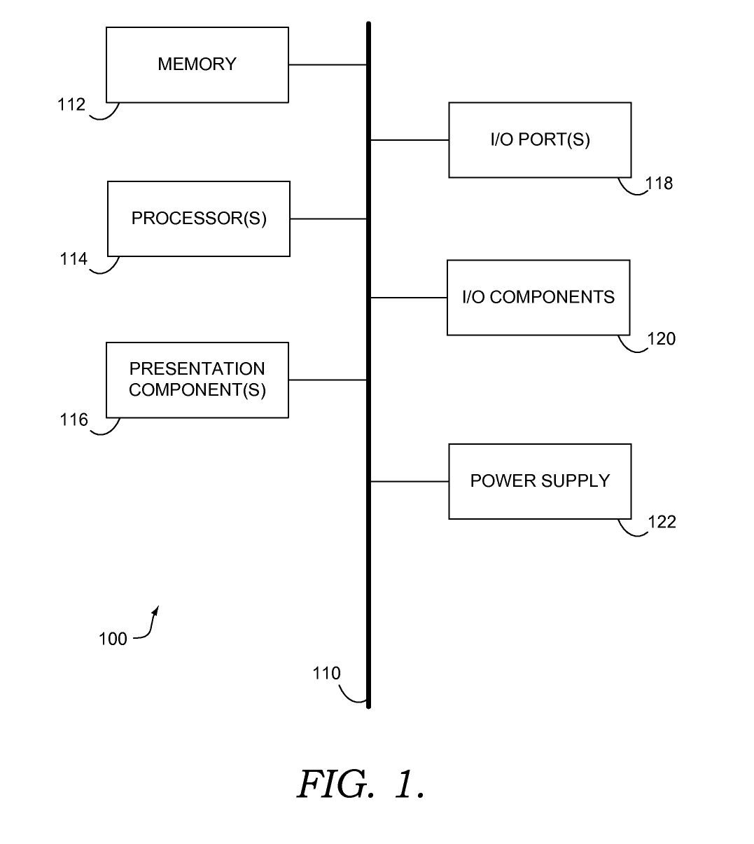

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “handheld device,” “smart phone,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

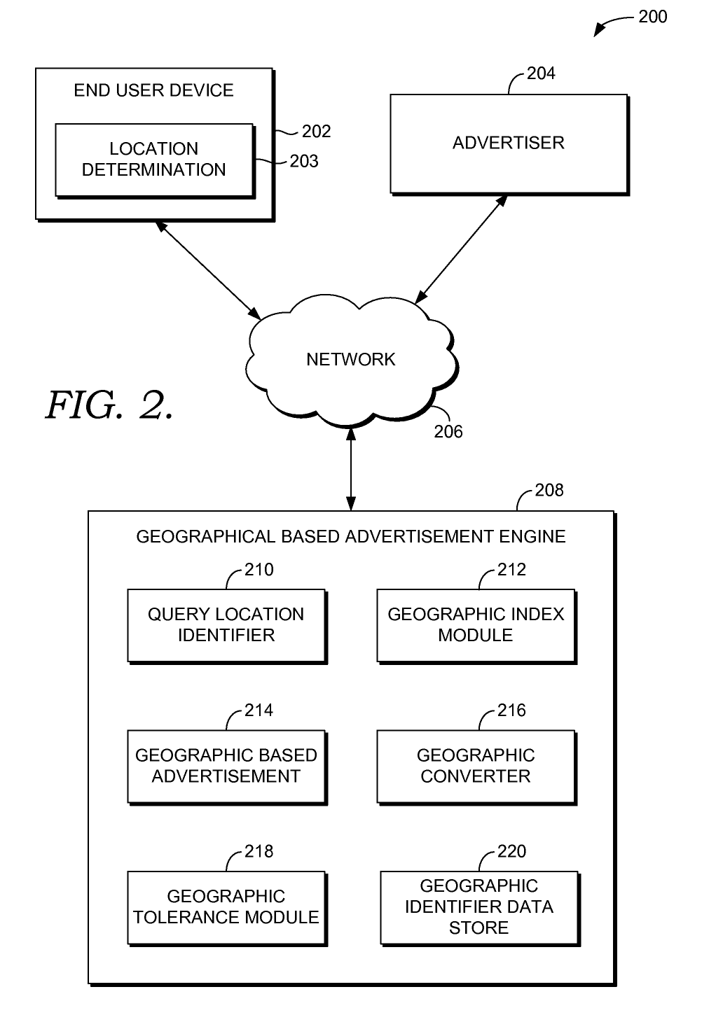

With reference to FIG. 2 that depicts an exemplary environment for geographically targeting online advertisements, as generally depicted by a numeral 200. Environment 200 includes an end user device 202, an advertiser 204, a network 206, and a geographical based advertisement engine 208. FIG. 2 is not intended to be limiting as to the scope of the present application, but instead provides a visual depiction as to an exemplary environment for geographically targeting online advertisements. Additionally, the inclusion or exclusion of any one, or combination of, modules and elements of FIG. 2 is not limiting as to the scope of the present application.

The end user device 202 is an originating source of a search query to which geographically relevant advertisements are matched. In an exemplary embodiment, the end user device 202 is a computing device, such as the computing device 100 previously discussed with reference to FIG. 1. Additionally, in an exemplary embodiment, the end user device 202 functions to present the geographically relevant advertisements to the user. The search query originates in response to, for example, a search engine, a mobile search platform, a directory, and/or a classified listing service.

In an exemplary embodiment, the end user device 202 allows a user to input a search query to be handled by a search engine that is accessible by way of the network 206. For example, the end user device 202 includes a display screen, such as the presentation module 116 previously discussed with respect to computing device 100. The display screen allows a user of the end user device 202 to view the search engine and to enter a search query by way of textually based commands, on-screen selection commands, and/or voice commands by way of an input module, such as I/O module 120.

Additionally, in an exemplary embodiment, the end user device 202 is a mobile communications device. A mobile communications device is functional to communicate by way of a wireless telecommunications network. For example, a wireless telecommunications network utilizes technologies compatible with the Third Generation Partnership Project (3GPP), the Third Generation Partnership Project 2 (3GPP2), IEEE 802.16 (e.g., WirelessMAN), and IEEE 802.11 (e.g. WiFi). 3GPP covers, among other technologies, all GSM technologies including General Packet Radio Service (GPRS) and Enhanced Data rates for GSM Evolution (EDGE) and W-CDMA specifications. 3GPP2 covers, among other technologies, Code Division Multiplexing (CDMA) 2000, a 3G standard based on earlier CDMA technologies. Therefore, the end user device 202 is capable of communicating with the search engine by way of a wireless telecommunications network. Examples of mobile communications devices include wireless phones, cellular phones, smart phones, Personal Data Assistants (PDA), and mobile computing devices.

In an additional exemplary embodiment, the end user device 202 includes a location determination module 203. The location determination module 203 determines the location of the end user device 202. For example, the location determination module 203 is compatible with a Global Positioning System (GPS) that is capable to determine the latitude and longitude of the end user device 202. In an additional exemplary embodiment, the location determination module 203 determines the approximate location of the end user device 202 utilizing trilateration. Trilateration uses the known locations of two or more reference points, such as mobile communications network transceivers, and the measured distance between the end user device 202 and each reference point. Another exemplary embodiment utilizes triangulation to determine the location of the end user device 202. Yet another exemplary embodiment utilizes multilateration to determine the approximate location of the end user device 202. Multilateration, also known as hyperbolic positioning, is the process of locating an object by accurately computing the time difference of arrival (TDOA) of a signal emitted from the object, such as the end user device 202, to three or more receivers. It also refers to the case of locating end user device 202 by measuring the TDOA of a signal transmitted from three or more synchronized transmitters to the end user device 202.

The location of the end user device 202 is also determinable based on input provided by the user of the end user device 202. For example, the user of the end user device 202 can provide a country/state/city, an address, latitude/longitude coordinates, and a point of interest (such as a known landmark or known location). Additionally, the location of the end user device 202, in an exemplary embodiment, is determined based on the context of the search query provided by way of the end user device 202. For example, if the search query includes an eating establishment that is determined to be in a single location, the location of the end user device 202 is inferred based on the context of the search query. In another exemplary embodiment, the location of the end user device 202 is determinable based on a known home location of the end user device 202. For example, the end user device 202 is associated with a profile that includes the general location from which the end user device 202 typically operates. This area that the end user device 202 typically operates is the end user's 202 home location. In an additional embodiment the end user's 202 home location is associated with a mobile communications device profile. Additionally, in an exemplary embodiment, the location of the end user device 202 is determinable based on an Internet Protocol (IP) address or other comparable identifier assigned to the end user device 202. IP addresses typically provide and indication as to the general geographic location of a computing device, such as end user device 202, by utilization of a reverse IP lookup based on the access point identification from which the end user device 202 is communicating.

In yet an additional exemplary embodiment, the location of the end user is determinable by way of historic information associated with the user of the end user device 202 or associated with the end user device 202. For example, if the end user device 202 is associated with a particular general location for previous search queries, but a recent location has not been provided, a default location that corresponds to the previous location is utilized. Continuing with the example, if a limited amount of time has elapsed since a last known location was provided/determined for the end user device 202, then the last known location is utilized as a default. The period of time that is utilized when determining if the previously known location is utilized is dynamic and can change depending on the type of end user device 202. For example, if the end user device 202 is a home computing device that is not typically mobile, then the time is defined in terms of hours, days, weeks, or months. However, if the end user device 202 is a mobile communications device that is highly mobile, then the period of time may be defined by seconds or minutes. Additionally, the period of validity for a previously known location is determined, in an exemplary embodiment, based on the number of location changes of the end user device 202 over a predefined period of time. For example, if the end user device 202 is associated with ten locations in a ten-day period in a first example and the end user device 202 is associate with ten location in a ten-hour period, the first example's previously known location will be valid for a longer time period than the second example's previously known location.

The above-discussed embodiments for determining the location of the end user device 202 are merely exemplary and are not limiting as to the scope of the present application. Additionally, it is understood that any combination of the embodiments for determining the location of the end user device 202 are functional to determine the location of the end user device 202.

In an exemplary embodiment, the direction of travel of the end user device 202 is determinable. For example, the location determination module 203 determines the direction of travel based on two or more consecutive locations identified. Continuing with the example, the location determination module 203 is capable of determining the end user's 202 location with a GPS. The location determination module 203 identifies the location of the end user device 202 at two instances, such that the direction of travel is determined based on the trend indicated by the two instances. The direction of travel is also determinable by user-provided information, such as a user indicated direction of travel by way of an input module, such as I/O module 120.

The advertiser 204 is a source of online advertisements. In an exemplary embodiment, the advertiser 204 is a computing device, such as computing device 100 previously discussed with respect to FIG. 1. The advertiser 204 facilitates the submission of online advertisements that are intended to be presented in response to a search query, such as a search query originating from the end user device 202. In an exemplary embodiment, an advertising entity, such as a marketing company or a purveyor of goods and/or services, will generate advertisements to be displayed to an audience. The advertisements created by the advertising entity are provided to the audience, in part, by the advertiser 204. For example, the advertiser 204 includes a user interface that facilitates the generation and submission of advertisements that will be displayed in response to a search query.

In an exemplary embodiment, the advertiser 204 facilitates the association of a geographic location with an advertisement. For example, an advertisement is designated, by the advertising entity, to be presented only to those search queries that are geographically relevant. The advertising entity therefore identifies a geographic location associated with the advertisement. Additionally, an area is identified by the advertising entity for which the advertisement is geographically relevant. For example, a small coffee shop located in a small town in Kansas is not typically geographically relevant to a search query for “local coffee shops” having a location of interest associated with the search query as Seattle, Wash. While the Kansas coffee shop is contextually relevant to the search query, the spatial discrepancy between Seattle, Wash. and small-town Kansas is not typically geographically relevant. Additionally, the location to be associated with the advertisement, in an exemplary embodiment, is identified based on a known location of the advertising entity or the entity to which the advertisement is directed. For example, online data stores maintain a searchable database of the location of business entities. The data store can be queried to identify a location associated with the advertising entity.

The spatial discrepancy between a location associated with the search query and the location associated with the advertisement is utilized to determine the geographic relevance. The less of a spatial discrepancy, the greater the geographic relevance. Typically, an inverse relationship exists between spatial discrepancy and geographic relevance.

A geographic tolerance, in an exemplary embodiment, is associated with a particular search query or an advertisement. The geographic tolerance sets the allowable spatial discrepancy for there to be geographic relevance. For example, a geographic tolerance for a local coffee shop advertisement is only a couple of miles from the coffee shop's location because the advertisement's effectiveness decreases with distances exceeding the geographic tolerance. The geographic tolerance is utilized to determine the geographic relevance of an advertisement to a search query.

The geographic tolerance of an advertisement, in a first exemplary embodiment, is provided by the advertising entity by way of the advertiser 204. For example, the advertising entity will provide information, metadata, which includes the geographic tolerance of an advertisement. The advertising entity can specify the geographic tolerance, for example, by indicating coordinates, country/city/state, zip codes, and/or areas on a map view for which the advertisement is relevant, therefore defining the geographic tolerance of the advertisement. The advertising entity is not limited to these embodiments for identifying the geographic tolerance, but instead the advertising entity may identify the geographic tolerance in additional ways. Such as, specifying a radius from the advertisement's identified location to identify the geographic tolerance of the advertisement.

A second exemplary embodiment for identifying the geographic tolerance of an advertisement utilizes the context of the advertisement or the metadata of the advertisement in combination with a predefined rule. For example, an advertisement that is determined to be associated with a local coffee shop, but the advertisement does not include an explicit geographic tolerance, is associated with a particular geographic tolerance based on the identification of the advertisement being from a local coffee shop. The automatic or semiautomatic association of a geographic tolerance is accomplished by identifying predefined rules that indicate that in general, local coffee shop advertisements are generally geographically relevant for a couple of miles. Therefore, the geographic tolerance of a local coffee shop advertisement is determined to be a couple of miles. The predefined rule can be created by monitoring the typical geographic tolerance selected by advertising entities associated with a related advertisement. The predefined rules can also be created by monitoring the relationship among the spatial discrepancy and the effectiveness of an advertisement.

The network 206 is a network or combination of networks that facilitate communication among the end user device 202, the geographical based advertisement engine 208, and the advertiser 204. Network 206, in an exemplary embodiment, is an IP based network, which is a computing network that utilizes IP protocol as a network layer protocol. The network may include, without limitation, one or more local networks, (LANs) and/or wide area networks (WANs). Such networking environments are commonplace in offices, enterprise-wide computer networks, intranets, and the Internet. Additionally, the network 206, in an exemplary embodiment includes a wireless telecommunications network, such as those previously discussed that are compatible with 3GPP and 3GPP2 technologies.

The geographical based advertisement engine 208 includes a query location identifier 210, a geographic index module 212, a geographical based advertisement data store 214, a geographic converter 216, a geographic tolerance module 218, and a geographic identifier data store 220.

The geographical based advertisement engine 208 provides a geographically relevant advertisement in response to a search query. In an exemplary embodiment, the end user device 202 communicates a search query by way of the network 206. The geographical based advertisement engine 208 provides geographically relevant advertisements, such as those provided by the advertiser 204, in response to the search query. For example, the geographical based advertisement engine 208 supplements an online search engine that is responsible for providing relevant results to the search query, but the geographical based advertisement engine 208 provides geographically relevant advertisements that are presented in conjunction with the online search engine results.

The query location identifier 210 identifies the geographic location of the search query received from the end user device 202. In an exemplary embodiment, the query location identifier extracts the location information provided by the location determination module 203. In an additional exemplary embodiment, the query location identifier 210 includes functionality discussed with respect to the location determination module 203. For example, the query location identifier 210 can determine the location of the end user based on the end user's 202 IP address, previously identified locations of the end user device 202, and the context or associated information of the search query. Additionally, the query location identifier 210, similar to the location determination module 203, can identify the location of travel of the end user device 202. For example, the query location identifier is able to determine a trend in locations associated with the end user device 202, such that the trend is converted to a direction of travel.

The geographic converter 216 converts the geographic location information into one or more geographic identifiers. The geographic converter 216 converts a geographic location associated with a search query or an advertisement into a geographic identifier. The conversion allows multiple formats of geographic location information to be conveyed into a common identifier format that is scalable depending on the required level of accuracy.

A geographic location is a location that is platform independent, such as a street address, geographic coordinates, and defined map areas. A geographic identifier is a platform dependent identifier. For example, a geographic identifier includes longitude/latitude identifiers and quadrant identifiers.

Longitude/latitude identifiers are determined based on dividing each degree of latitude and longitude into specified equidistant portions. For example, each degree of latitude and longitude can be divided into sixty equidistant portions. Therefore, a geographic location can be identified by a geographic identifier, which is associated with an area associated with a particular longitudinal segment as intersected by a particular latitudinal segment that identifies an area. The area of the geographic identifier includes the geographic location. The number of equidistant portions of each degree of longitude and latitude is variable depending on the desired accuracy of the geographic identifier. For example, if a high degree of accuracy is required for providing a geographic identifier, more segments will be used per degree than if a lower degree (less precise) of accuracy is required.

Quadrant identifiers are determined by dividing a geographic area into increasing exponential quadrants. For example, initially the area defined by the world is divided into quadrants (four equally portioned areas), this results in a number of areas equal to four to the first power. Each of these quadrants are then divided into four additional quadrants resulting in a number of areas equal to four to the second power, sixteen. Continuing, if the sixteen areas are each divided into quadrants, the resulting number of areas equally results in a number of equally portioned areas of four to the third power, sixty-four. The exponential power utilized to divide an area, such as the world is determined based on the desired accuracy, similar to the longitude/latitude identifier methodology. An identifier is assigned to each of the resulting quadrants of the highest power. Returning to the previous example that included sixty-four defined areas, each area is provided an identifier, such as a number one through sixty-four.

The geographic tolerance module 218 identifies the geographic tolerance of an advertisement. The geographic tolerance, as previously described, can be explicitly indicated by the advertising entity. The geographic tolerance can also be identified based on information associated with the advertisement, including the context of the advertisement. For example, a local coffee shop advertisement, where the geographic tolerance is not explicitly provided, is associated with a geographic location of latitude 39.035 and longitude −94.609 and is determined to have a one square mile geographic tolerance based on the effective spatial discrepancy for a local coffee shop in an urban environment. Therefore, the geographic tolerance module 218 identifies all geographic identifiers included in the area defined by the geographic tolerance centered on the geographic location of the coffee shop. As a result, multiple geographic identifiers are now associated with the advertisement. The plurality of geographic identifiers are stored in the geographic identifier data store 220.

The geographic identifier data store 220 is a data store that stores the association of geographic identifiers in association with an advertisement. In an exemplary embodiment, the geographic identifier data store 220 is a computing device having a memory and processor, such as computing device 100 previously discussed with respect to FIG. 1. In an exemplary embodiment, the geographic identifier data store 220 facilitates the storage of geographic identifiers that define an area that includes the geographic location of the advertisement in addition to the geographic tolerance of the advertisement. Therefore, advertisements can be matched with a search query that is identified to be associated with a particular geographic identifier based on a common geographic identifier.

The geographical based advertisement data store 214 is a data store that stores the advertisements utilized when selecting a geographically relevant advertisement. In an exemplary embodiment, the geographical based advertisement data store 214 is populated with advertisements from the advertiser 204. For example, when an advertising entity generates an advertisement by way of the advertiser 204, the advertisement is maintained by the geographic advertisement data store 214. Therefore, when an advertisement is selected based on the advertisement's geographic relevance to a search query, the selected advertisement is extracted from the geographical based advertisement data store 214 to be presented to a user.

The geographic index module 212 matches advertisements with search queries based on geographic relevance. For example, a search query is received from the end user device 202. A geographic location of the search query is identified by the query location identifier 210. The geographic location of the search query is converted to a geographic identifier 220 by the geographic converter 216. The geographic index module 212 utilizes the geographic identifier of the search query to identify one or more advertisements from the geographical based advertisement data store 214 that are geographically relevant. Continuing with this example, the geographic index module 212 determines the advertisement is geographically relevant if a common location identifier exists with the search query and the advertisement, the advertisement has multiple location identifiers from the geographic tolerance module 218 that are stored in the geographic identifier data store 220.

In an additional exemplary embodiment, the geographic tolerance module 218 identifies a geographic tolerance of the search query. For example, based on the context of the search query, the geographic tolerance module 218 identifies a geographic tolerance of the search query. The geographic identifiers that define the area that includes the geographic tolerance are utilized by the geographic index module 212 to identify advertisements geographically relevant to the search query. Therefore, the advertisement can control the geographic area that is relevant, or the search query can control the geographic area that is relevant. Additionally, a combination of the two can be utilized to identify those advertisements geographically relevant.

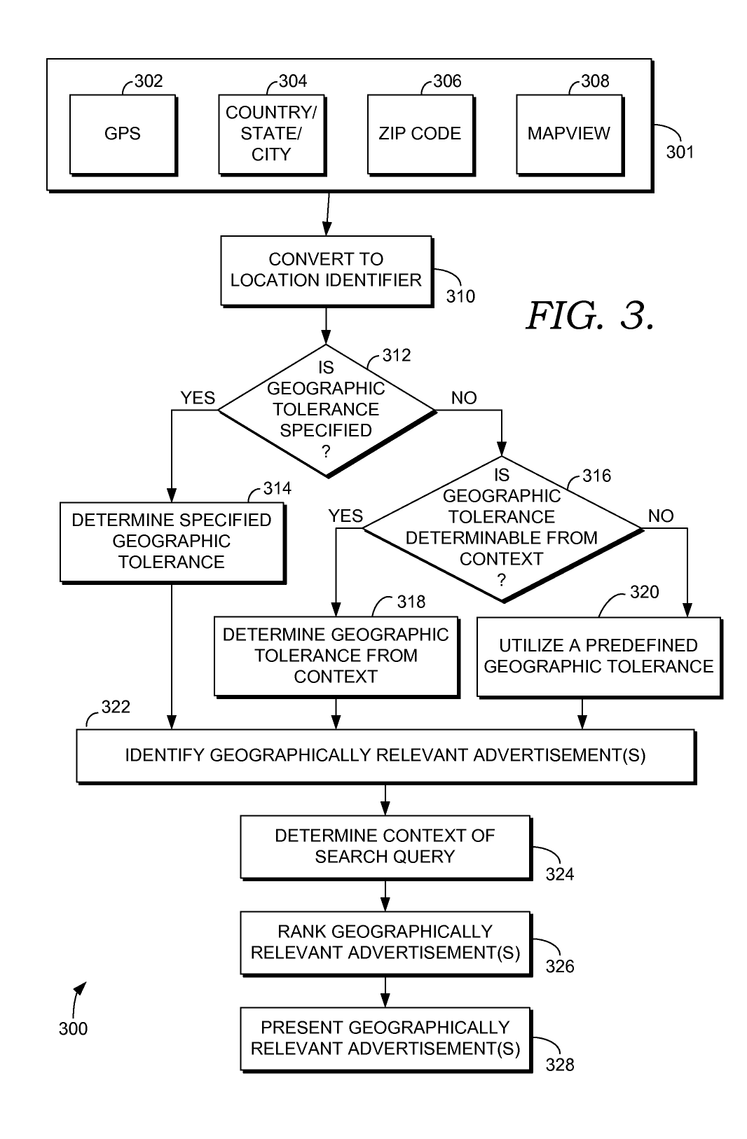

Turning now to FIG. 3 that represents an exemplary method for geographically targeting online advertisements as generally depicted by the numeral 300. At a step 301, an advertisement is received that includes information useable to identify an associated geographic location. For example, the geographic location of the advertisement is identifiable from GPS information 302, country/state/city information 304, zip code information 306, and/or map view boundary information 308. The sources 302-308 of geographic location information are not exhaustive, but instead merely exemplary sources. Additional sources include, but are not limited to, explicitly identified geographic location information and contextually derived geographic location information.

At a step 310, the geographic converter 216 converts the geographic location to a location identifier. For example, the geographic location as identified by GPS 302 is converted to an identified quadrant from the previously described quadrant identifier methodology. At a determination 312, a determination is made if a geographic tolerance is specified for the received advertisement. If a geographic tolerance is specified, at a step 314 the geographic tolerance module 218 determines the geographic tolerance of the advertisement. If, however, the determination 312 is that a geographic tolerance is not specified, a determination 316 is performed. The determination 316 determines if a geographic tolerance is determinable from the context of the advertisement. For example, if the advertisement is directed to an industry, field, product, or service that is associated with a predefined rule (previously discussed), then a geographic tolerance may be determinable based on the context of the advertisement. If a geographic tolerance can be determined from the context of the advertisement, then at a step 318, the geographic tolerance module 218 determines the geographic tolerance from the context of the advertisement. If, however, a geographic tolerance is not determinable from the context of the advertisement, then at a step 320 a predefined geographic tolerance is utilized. The predefined geographic tolerance can be based on the particular advertising entity associated with the advertisement or it can be a generic predefined geographic tolerance.

At a step 322, the geographic index module 212 identifies geographically relevant advertisements to a search query. As previously discussed, a geographically relevant advertisement includes those advertisements that share a common geographic identifier as to an identifier associated with the search query.

At a step 324, the context of the search query is determined. The context of the advertisement is utilized to identify those advertisements that are contextually related to the search query. Methods for identifying the context of the search query are known and understood by those having ordinary skill in the art, and therefore are not discussed in greater detail herein.

At a step 326, the advertisements identified as geographically relevant at the step 322 are then ranked based on their geographic relevance and contextual relevance to the search query. In an additional exemplary embodiment, additional factors are utilized in the ranking performed at the step 326. For example, the amount paid by an advertising entity to have an advertisement presented will be considered when ranking the geographically relevant advertisements. It is understood by those having ordinary skill in the art that the geographically relevant advertisements are not required to be identified prior to identifying the context of the search query. Instead, in an exemplary embodiment, the context of the search query is determined and the advertisements contextually related to the search query are then identified as being geographically relevant.

At a step 328, one or more of the advertisements that are determined to be geographically relevant are presented (displayed) and temporally stored on computer readable storage media. In an exemplary embodiment, the presentation of geographically relevant advertisements includes communicating the geographically relevant advertisements to the end user device 202 by way of the network 206 from the geographical based advertisement engine 208.

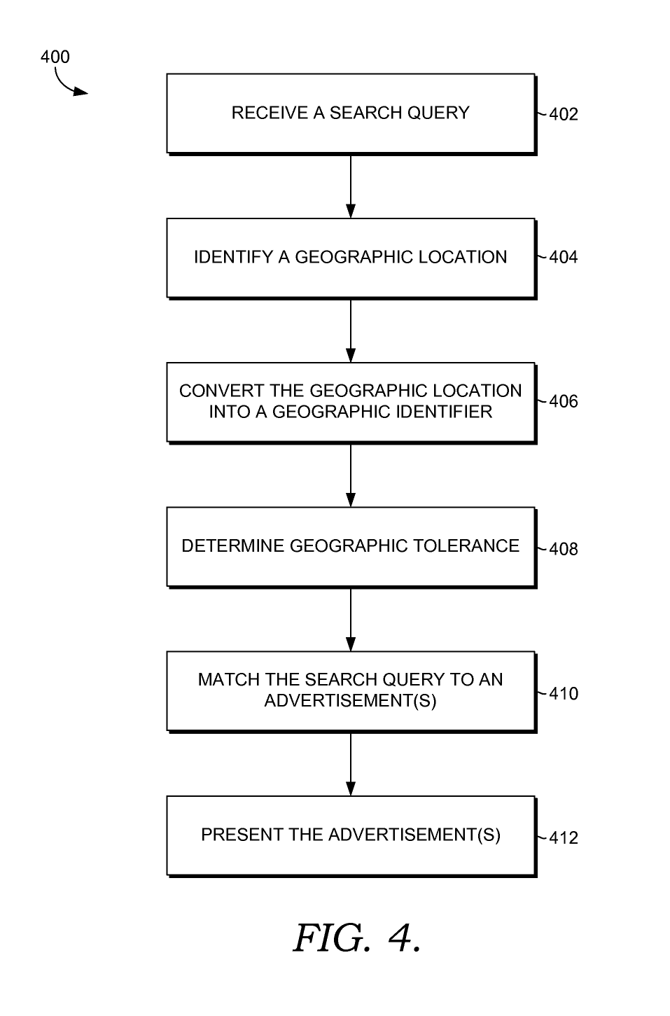

Turning now to FIG. 4 that depicts an exemplary method for geographically targeting online advertisements, in accordance with embodiments of the present invention. The method for geographically targeting online advertisements is generally depicted by the numeral 400. At a step 402, the geographical based advertisement engine 208 receives a search query. The search query originated from the end user device 202. At a step 404, the query location identifier 210 identifies a geographic location associated with the search query. In an exemplary embodiment, the geographic location is determined from metadata associated with the search query. The location determination module 203 provides the metadata that is supplied with the search query.

At a step 406, the geographic converter 216 converts the geographic location into a geographic identifier. At a step 408, the geographic tolerance module 218 determines the geographic tolerance of the search query. For example, a search query that is directed to a local coffee shop will be determined to have a much smaller geographic tolerance than a search query for a national retailer that typically results in spatially disparate results.

At a step 410, the search query is matched to one or more advertisements that are within the geographic area defined by the geographic tolerance of the search query. In addition to matching the advertisement to the search query based on geographic relevance, a contextual relationship is utilized to appropriately match advertisements to search queries. At a step 412, the geographical based advertisement engine 208 facilitates the presentation of the geographically relevant advertisements. In an exemplary embodiment, the geographical based advertisement engine 208 communicates the geographically relevant advertisements to the end user device 202 to supplement search engine results for the search query.

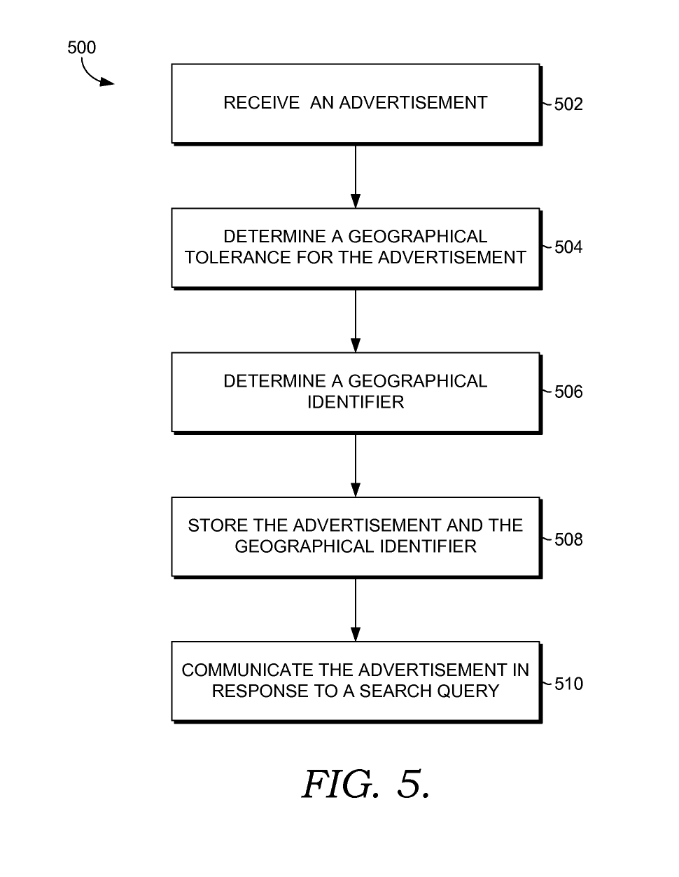

Turning now to FIG. 5 that depicts an exemplary method for geographically targeting online advertisements, in accordance with embodiments of the present invention. At a step 502, the geographical based advertisement engine 208 receives an advertisement from the advertiser 204. In an exemplary embodiment, the advertisement includes information relating to the geographic location associated with the advertisement. The geographic location can be explicitly included, such as by the advertising entity at the time of submission of the advertisement to the advertiser 204. On the other hand, the geographic location can also be inherently included, such as by the context of the advertisement.

In an exemplary embodiment, the advertisement is a dynamic advertisement that allows the advertisement to be altered based on characteristics relating to the search query. For example, a national coffee chain that has a plurality of local coffee shops can generate an advertisement that does not include address information. However, the geographical based advertisement engine 208 determines that one of the national coffee chain's local shops is within a geographically relevant area of a search query. Upon the determination of the geographic relevance, the geographical based advertisement engine 208 populates the dynamic advertisement with information pertaining to the local coffee shop. Therefore, a single dynamic advertisement is able to be altered for each of the local coffee shops based on the local coffee shops geographic relevance to the search query. Additional examples of information associated with the local coffee shop include, but are not limited to, hours of operation, phone number, coupons, specials, announcements, and driving directions based on the location of the end user device 202 and the geographically relevant coffee shop can also be incorporated into the dynamic advertisement. It is understood by those with ordinary skill in the art that the “coffee shop” is merely utilized as an exemplary advertising entity and is not limiting as to the scope of the dynamic advertisement.

At a step 504, the geographic tolerance module 218 determines a geographic tolerance for the advertisement. For example, the advertising entity can specify the geographic tolerance of the advertisement. Alternatively, the geographic tolerance is determinable based on predefined rules, such as those rules previously discussed.

At a step 506, the geographic converter converts the geographic location of the advertisement to a geographic identifier. Additionally, in an exemplary embodiment, the geographic converter 216 converts the geographic area defined by the geographic tolerance of the advertisement to one or more geographic identifiers. As a result, one or more geographic identifiers are associated with the advertisement, such that the areas defined by the geographic identifiers identify the geographic area to which the advertisement is geographically relevant.

At a step 508, the geographic identifier data store 220 stores the association between the advertisement and the one or more geographic identifiers identified at step 506. In an exemplary embodiment, the geographic identifier data store 220 indexes the advertisement so that a search query that includes a geographic identifier can be matched to one or more advertisements that are associated with a similar geographic identifier.

At a step 510, the geographical based advertisement engine 208 communicates the advertisement in response to a geographically relevant search query. In an exemplary embodiment, the advertisement is communicated from the geographical based advertisement engine 208 to the end user device 202 by way of the network 206.

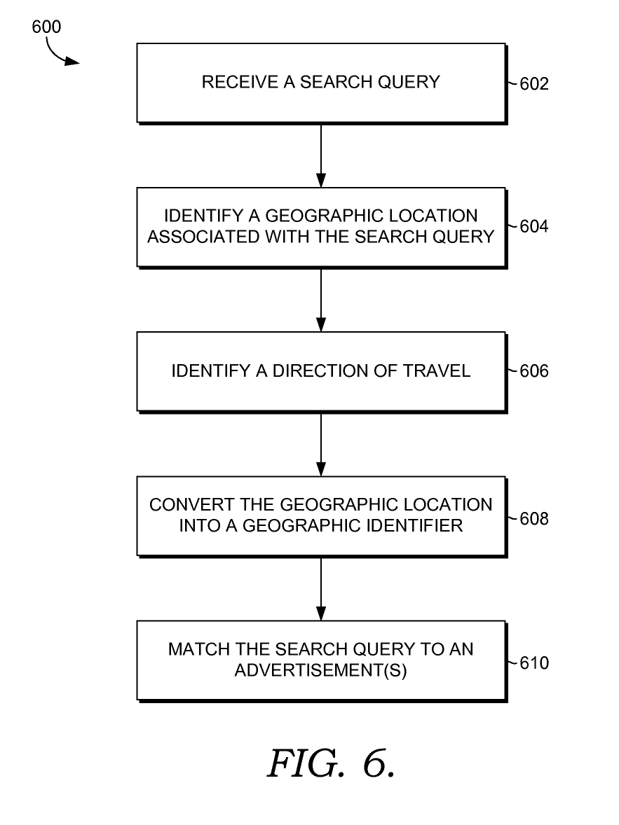

Turning to FIG. 6 that depicts an exemplary method for geographically targeting online advertisements, in accordance with embodiments of the invention. The method is generally depicted by the numeral 600. At a step 602, the geographical based advertisement engine 208 of FIG. 2 receives a search query. For example, the search query is received from a user of the end user device 202 of FIG. 2. At a step 604, the query location identifier 210 of FIG. 2 identifies the geographic location associated with the search query. In one example, the geographic location is determined based on the context of the search query. For example, if the search query includes a restaurant in a particular town, then the town is utilized to determine the geographic location to be associated with the search query. The geographic location is also determinable based on information received with the search query. For example, information, such as metadata, that is provided by the location determination module 203 is useable to identify the geographic location that is to be associated with the search query.

At a step 606, the direction of travel associated with the search query is identified. The direction of travel is beneficial for the matching and ranking of geographically relevant advertisements. For example, if the location of the end user is identified by a GPS as traveling on an interstate, just past an exit from the interstate, and the direction of travel is indicated as heading north, then the advertisements relating to advertising entities that are north of the current location should be ranked higher than those with geographic locations to the south. Continuing with this example, if the end user device 202 is just north of an exit on the interstate and searches for a local coffee shop, the coffee shop at the just passed exit, which is closer than the coffee shop at the next exit will have a lower ultimate ranking. This is because the end user 220 is known to be heading north and the process of turning around is less efficient then continuing to drive north to the next exit that also has a coffee shop. In addition to direction of travel, driving directions, estimated travel time, traffic conditions, and efficient use of resources, all utilizing the geographic location of the end user 220 and the advertisement, are all useable for ranking the geographically relevant advertisements.

At a step 608, the geographic converter 216 converts the geographic location identified at step 604 into a geographic identifier. At a step 610, the geographic index module 212 matches the search query to one or more advertisements stored by the geographical based advertisement data store 214. The matching is based on the geographic identifier determined at step 608, the identified direction of travel identified at step 606, and a geographic tolerance associated with each of the one or more advertisements.

What is claimed is:

1. One or more computer-storage media having computer-executable instructions embodied thereon for performing a method of geographically targeting online advertisements, the method comprising:
receiving a search query from a user;
identifying a geographic location associated with the search query;
converting the geographic location into a geographic identifier;
determining a geographic tolerance for the search query, wherein the geographic tolerance is a measurement of acceptable spatial discrepancy between the search query geographic identifier and an advertisement's geographic identifier;
matching the search query to one or more advertisements based on the geographic identifier and the geographic tolerance; and
presenting the one or more advertisements.

2. The media of claim 1, wherein the geographic location is defined by latitude and longitude, and the geographic identifier is defined by an area of a grid.

3. The media of claim 1, wherein the search query is received from a mobile communications device.

4. The media of claim 3, wherein the geographic location is determined by technologies compatible with at least one from the following,
(A) Global Positioning Sensor (GPS),
(B) Trilateration,
(C) Triangulation,
(D) Multilateration,
(E) Mobile communications device profile information, and
(F) Access point identification.

5. The media of claim 3, wherein the geographic location is determined by user-provided location information.

6. The media of claim 3, wherein the geographic location is determined by historical geographic information associated with the user.

7. The media of claim 3 further comprising calculating a direction of travel based on information received from the user.

8. The media of claim 1, wherein the advertisements are associated with one or more geographic identifiers.

9. The media of claim 1 further comprising:
receiving the one or more advertisements;
receiving an indication of one or more geographic locations associated with each member of the one or more advertisements; and
converting the one or more geographic locations into one or more geographic identifiers.

10. The media of claim 1, wherein the geographic tolerance is based on a geographically relevant area associated with at least one member of the one or more advertisements.

11. The media of claim 1, wherein the geographic tolerance is determined based, in part, on historical information relating to the search query.

12. A method of geographically targeting online advertisements to a search query, the method comprising:
receiving an advertisement from an advertiser, wherein the advertisement is associated with one or more geographic locations;
determining a geographic tolerance for the advertisement;
determining one or more geographic identifiers to associate with the advertisement based on the one or more geographic locations and the determined geographic tolerance, wherein the one or more geographic identifiers indicate a geographic area that correlates to the one or more geographic locations including the determined geographic tolerance;
storing the advertisement in association with the one or more geographic identifiers; and
communicating the advertisement in response to a search query that is relevant to the advertisement and the advertisement's associated one or more geographic identifiers.

13. The method of claim 12, wherein the geographic tolerance is based on a geographically relevant area associated with a context of the advertisement.

14. The method of claim 12, wherein the advertisement is associated with the one or more geographic locations as determined by an advertiser associated with the advertisement.

15. The method of claim 12, wherein the advertisement is associated with the one or more geographic locations as determined by context of the advertisement.

16. The method of claim 12, wherein the geographic relevance is determined by an advertiser associated with the advertisement.

17. The method of claim 12, wherein the geographic tolerance is determined based on the context of the advertisement.

18. The method of claim 12, wherein the search query is relevant to the advertisement when a location identifier associated with the search query corresponds to a member of the one or more geographic identifiers of the advertisement.

19. The method of claim 12, wherein the search query is relevant to the advertisement when a user associated with the search query is moving in a direction toward a member of the one or more geographic identifiers of the advertisement.

20. A method of geographically targeting online advertisements to a search query, the method comprising:
receiving a search query from a user;
identifying a geographic location associated with the search query by detecting the geographic location from the context of the search query or from information received in addition to the search query;
identifying a direction of travel associated with the user, wherein the direction of travel is based on the information received in addition to the search query;
converting the search query geographic location into a geographic identifier;
matching the search query to one or more advertisements based on the geographic identifier, the identified direction of travel, and a geographic tolerance associated with each member of the one or more advertisements, wherein the geographic tolerance is determined based on the context of each member of the one or more advertisements or by an advertiser associated with each member of the one or more advertisements; and
presenting the one or more advertisements.
